(19) United States
(12) Patent Application Publication
(10) Pub. No.: US 2019/0070613 A1
(43) Pub. Date: Mar. 7, 2019

(54) SEALING ASSEMBLY FOR GYRATORY CRUSHER

(71) Applicant: SANDVIK INTELLECTUAL PROPERTY AB, Sandviken (SE)

(72) Inventors: Anne HOLMBERG, Loddekopinge (SE); Fredrik ERIKSSON, Malmo (SE)

(21) Appl. No.: 16/082,535

(22) PCT Filed: Mar. 7, 2016
(86) PCT No.: PCT/EP2016/054722

§ 371 Date: Sep. 5, 2018

(51) Int. Cl. B02C 2/04

(52) U.S. Cl. CPC B02C 2/042; B02C 2/06

(57) ABSTRACT

A gyratory crusher sealing assembly provides a seal between a discharge zone positioned below a crushing chamber and a working part zone of the crusher that accommodates various bearing assemblies and drive components that provide gyroscopic precession of the head and inner crushing shell within the crusher. The sealing assembly includes a reusable carrier ring having a radially inner region, a radially outer region, an upper side and a lower side, and at least one seal releasably mounted on the carrier ring that is arranged for sealing engagement with a sealing part. The seal protrudes beyond a mounting region of the carrier ring such that, in use, the seal maintains the carrier ring out of engagement with the sealing part.

### FIELD OF INVENTION

The present invention relates to a sealing assembly for a gyratory crusher and a gyratory crusher comprising the same.

### BACKGROUND ART

Gyratory crushers are used for crushing ore, mineral and rock material to smaller sizes. Typically, the crusher comprises a crushing head mounted upon an elongate main shaft. A first crushing shell (typically referred to as a mantle) is mounted on the crushing head and a second crushing shell (typically referred to as a concave) is mounted on a frame such that the first and second crushing shells define together a crushing chamber through which the material to be crushed is passed. A driving device positioned at a lower region of the main shaft is configured to rotate an eccentric assembly arranged about the shaft to cause the crushing head to perform a gyratory pendulum movement and crush the material introduced in the crushing chamber. Example gyratory crushers are described in WO 2004/110626; WO 2008/140375, WO 2010/123431, US 2009/0008489, GB 1570015, U.S. Pat. No. 6,536,693, JP 2004-136252, U.S. Pat. No. 1,791,584 and WO 2012/005651.

Conventionally, the driving device interfaces with the drive components and bearings that provide and stabilize the gyroscopic precession of the shaft and crushing head within the crusher. These working parts are typically accommodated within a working part zone that is partitioned and sealed from the crushing chamber and the discharge zone (through which crushed material passes) by a sealing arrangement. The sealing arrangement commonly comprises a sealing ring that is journalled in sealing contact against a dust collar positioned at the interface between the working part zone and the discharge zone. Typically, the sealing ring is formed as an annular body where an inner surface of the annulus provides the sealing contact against an outer surface of the dust collar.

One problem with this type of sealing arrangement is that the sealing ring is typically made from a polymer material, such as nylon. In operation, the sealing ring undergoes thermal expansion thereby creating a gap between the sealing ring and the dust collar. This problem has been addressed to some extent by JP2004-136252 by modifying the nylon sealing ring to include a rubber, V-Shaped, seal. The V-shaped seal maintains some contact with the dust collar when the sealing ring is in its thermally expanded state, due to the elasticity of the rubber seal. However, this is not an optimised solution. As will be appreciated, due to the shape of the rubber seal, sealing contact is only made at the tip of the rubber seal when the sealing ring is in its thermally expanded state, and rubber wears very quickly. Also, the sealing ring wears with use. When the sealing ring is worn beyond its useful limit, it cannot be reused but rather is discarded. The sealing ring is a relatively large and expensive component, which is costly to replace. Sealing rings of this type are also prone to damage by water and dust particles.

Accordingly a sealing arrangement is required that mitigates at least one of these problems.

### SUMMARY OF THE INVENTION

The invention relates to a sealing arrangement for a gyratory crusher, which separates the discharge zone of the crushing chamber and a working part zone that accommodates the drive and bearing assemblies associated with the main shaft and crushing head.

It is an object of the present invention to provide a sealing assembly that mitigates the effects of at least one of heat, water and dust particles on the operational effectiveness of the sealing arrangement. It is a further object to provide a sealing assembly which is optimised to minimise the cost of replacing worn components. It is a further objective to extend as far as possible, the longevity of the sealing assembly to reduce the frequency for maintenance and replacement of the seal wear parts. It is a further object to provide a sealing assembly, wherein the wearable components are easy to manufacture and replace.

The objectives are achieved by providing a sealing assembly, which includes a reusable carrier ring and at least one seal releasably mounted on the carrier ring. The seal is arranged for sealing engagement with a sealing part, such as the dust collar or seat attached to the head. The sealing function is provided by the seal. The carrier ring itself does not provide a sealing function, and therefore does not wear due to frictional engagement with the sealing part. Since the carrier ring does not provide a sealing function, it can be made from a material that is that is more resistant to the effects of heat, water and/or dust particles. For example, according to a specific implementation, the carrier ring can include metal, such as at least one of aluminium and steel. Metals such as aluminium and steel tend to have lower coefficients of thermal expansion than polymers used for sealing rings. Therefore a metallic carrier ring of similar size to a prior art sealing ring, undergoes less thermal expansion than the sealing ring, in use. The carrier ring can include a composite material such as carbon fibre and/or glass fibre. The carrier ring can have a composite structure, which includes a plurality of materials. Thus the sealing assembly according to the invention helps to maintain the seal in sealing contact with the sealing part.

The carrier ring is reusable since it does not wear in the same way as a prior art sealing ring. In the present invention, only the seals mounted on the carrier ring wear. Accordingly, it is only necessary to replace the or each seal mounted on the carrier ring, and therefore the cost of replacing worn components is less than the cost of replacing an entire prior art sealing ring.

The or each seal mounted on the carrier ring can have a simple construction. According to the specific implementation, the or each seal can be formed from a flexible elongate body. The body is cut to the appropriate length and bent to conform to the shape of a part of the carrier ring. For example, the elongate body can be bent into a substantially annular shape. The elongate body can be bent into a segment of a substantially annular shape. A seal of this type is easy to mount on to, and remove from, the carrier ring. The same type of flexible elongate body can be used for each seal mounted on the carrier ring. This helps to minimise the cost of replacing worn parts.

According to a first aspect of the present invention there is provided a sealing assembly for a gyratory crusher, said gyratory crusher having a crushing chamber defined between an outer and an inner crushing shell with a discharge zone to allow crushed material out of the crushing chamber, the inner crushing shell supported on a head mounted at a main shaft, wherein a working part zone is positioned below the head and about the shaft and comprises working parts to enable the head to move gyroscopically within the crusher, and the sealing assembly is configured for positioning between the discharge zone and the working part zone, and comprises: a reusable carrier ring having a radially inner region, a radially outer region, an upper side and a lower side; and at least one seal releasably mounted on the carrier ring that is arranged for sealing engagement with a sealing part.

The seal protrudes beyond a mounting region of the carrier ring. The arrangement is such that, in use, the seal maintains the carrier ring out of engagement from the sealing part. The seal is substantially annular.

In some embodiments the seal is mounted on the carrier ring in the radially inner region. The seal protrudes beyond the carrier ring in a radially inwards direction. The seal maintains a radially innermost part of the carrier ring out of engagement from the sealing part.

In some embodiments the seal protrudes outwardly from the carrier ring in a direction that is substantially transverse to a radial direction.

In some embodiments the seal protrudes outwardly from the lower side of the carrier ring. The seal maintains the lower surface of the carrier ring out of engagement from the sealing part.

In some embodiments the seal protrudes outwardly from the upper side of the carrier ring. The seal maintains the upper surface of the carrier ring out of engagement from the sealing part.

In some embodiments the seal protrudes from a radially outer region of the carrier ring. The seal maintains the radially outer region of the carrier ring out of engagement from the sealing part.

In some embodiments the sealing assembly includes a plurality of substantially annular seals mounted on the carrier ring.

In preferred embodiments the at least one seal includes: a first seal releasably mounted on the carrier ring in the radially inner region. The first seal is mounted on to the carrier ring at a first radial distance. The first seal protrudes beyond the carrier ring in a radially inwards direction to sealingly engage a first sealing part. Preferably the first seal is substantially annular. Preferably the first sealing part comprises a non-rotating part such as an annular dust collar. The first seal maintains the carrier ring out of sealing engagement with the first sealing part.

In preferred embodiments the at least one seal includes: a second seal releasably mounted on the carrier ring. The second seal is positioned on the carrier ring at a second radial distance. The second radial distance is larger than the first radial distance. Preferably the second seal protrudes outwardly from the lower side of the carrier ring to sealingly engage with a second sealing part. Preferably the second seal is substantially annular. Preferably the second sealing part comprises a rotating part such as the head and/or a seat which is attached to the head. The seat can comprise a retaining ring. The second seal maintains the carrier ring out of sealing engagement with the second sealing part.

In preferred embodiments the at least one seal includes: at least one additional seal releasably mounted on the carrier ring. The additional seal is positioned on the carrier ring at a radial distance that is larger than the first radial distance, and different from the second radial distance. Preferably the additional seal protrudes outwardly from the lower side of the carrier ring to sealingly engage the second sealing part. The additional seal maintains the carrier ring out of sealing engagement with the second sealing part. Preferably the sealing assembly includes at least two additional seals releasably mounted on the carrier ring.

In preferred embodiments the second seal and additional seal have a stepped protruding arrangement. Preferably the second seal protrudes beyond the additional seal in the downwards direction.

Optionally the first seal is seated in a first annular groove formed in the carrier ring. The first annular groove faces radially inwards.

Optionally the second seal is seated in a second annular groove. The second annular groove faces in a direction that is substantially perpendicular to the first groove. Preferably the second groove is formed in the lower side of the carrier ring. The second annular groove faces downwards.

Optionally the or each additional seal is seated in the second annular groove. Alternatively, a separate groove can be formed in the lower side for each additional seal.

In preferred embodiments at least one of the seals comprises a flexible elongate body having first and second ends. The flexible elongate body is bendable to conform to the shape of the carrier ring. For example, is bendable into a substantially annular shape. In this arrangement the first end of the flexible body is located adjacent to the second end of the flexible body. In some embodiments the flexible elongate body is bent into a segment of an annulus. The seal can include a plurality of flexible elongate bodies. Preferably the plurality of flexible elongate bodies are arranged on the carrier ring in a substantially annular shape.

Thus a substantially annular seal can be provided from at least one linear body. This enables different sized seals to be made from the same stock material, simply by cutting the stock material to the appropriate length to match the appropriate circumferential dimension.

Preferably a plurality of seals each comprises at least one flexible elongate body having first and second ends.

In preferred embodiments the flexible elongate body has a substantially rectangular transverse cross-section.

In preferred embodiments at least one seal includes a polymer based material, such as a polyethylene based material and/or a composite material such as carbon fibre, or glass fibre.

The carrier ring comprises an annular body. In some embodiments the body includes metal. For example, the body can include aluminium and/or steel. The body can include a composite material. For example, the body can include carbon fibre and/or fibre glass. The body can be made from a single material. Alternatively the body can include a plurality of different materials.

In preferred embodiments the carrier ring includes at least one formation, such as at least one through hole, which is arranged to receive a tool, the tool being used to remove at least one seal from the carrier ring.

According to another aspect of the invention there is provided a gyratory crusher comprising: an outer and an inner crushing shell with a crushing chamber defined therebetween; a discharge zone to allow crushed material out of the crushing chamber; a head mounted upon a main shaft and configured to support the inner crushing shell; a plurality of working parts positioned below the head about the main shaft within a working part zone to enable the head to move gyroscopically within the crusher; a sealing assembly positioned at an interface between the discharge zone and the working part zone, the sealing assembly comprising: a reusable carrier ring having a radially inner region, a radially outer region, an upper side and a lower side; and at least one seal releasably mounted on the carrier ring that is arranged for sealing engagement with a sealing part.

The seal protrudes beyond a mounting region of the carrier ring. In normal use, the seal maintains the carrier ring out of sealing engagement from the sealing part.

In preferred embodiments an annular dust collar is positioned about the main shaft at the interface between the discharge zone and the working part zone. The sealing assembly is positioned in sealing contact with a radially outward facing surface of the dust collar. Preferably a first seal is in sealing contact with the dust collar.

In preferred embodiments the crusher includes a seat provided at a lower region of the head. The seat is configured to support the sealing assembly in position between the head and the dust collar. The sealing assembly is positioned in sealing contact with an upper surface of the seat. Preferably a second seal is in sealing contact with the seat.

Preferably the seat is releasably attached to a lower region of the head by a plurality of attachment elements.

According to another aspect of the invention there is provided a sealing assembly for a gyratory crusher, said gyratory crusher having a crushing chamber defined between an outer and an inner crushing shell with a discharge zone to allow crushed material out of the crushing chamber, the inner crushing shell supported on a head mounted at a main shaft, wherein a working part zone is positioned below the head and about the shaft and comprises working parts to enable the head to move gyroscopically within the crusher, and the sealing assembly is configured for positioning between the discharge zone and the working part zone, and comprises: a carrier ring having a radially inner region, a radially outer region, an upper side and a lower side; and at least one seal releasably mounted on the carrier ring, said seal being arranged for sealing engagement with a sealing part, wherein the seal includes at least one flexible elongate body having first and second ends, wherein the flexible elongate body is bent to conform to the shape of a part of the carrier ring.

In some embodiments the flexible elongate body is bent into a substantially annular shape.

In some embodiments the elongate body is bent into a segment of an annulus. The seal can include a plurality of flexible elongate bodies. Preferably the plurality of flexible elongate bodies are arranged on the carrier ring in a substantially annular shape.

In preferred embodiments the sealing assembly includes a plurality of seals. Preferably each seal comprises at least one flexible elongate body having first and second ends.

According to another aspect of the invention there is provided a gyratory crusher comprising: an outer and an inner crushing shell with a crushing chamber defined therebetween; a discharge zone to allow crushed material out of the crushing chamber; a head mounted upon a main shaft and configured to support the inner crushing shell; a plurality of working parts positioned below the head about the main shaft within a working part zone to enable the head to move gyroscopically within the crusher; a sealing assembly positioned at an interface between the discharge zone and the working part zone, the sealing assembly comprising: a carrier ring having a radially inner region, a radially outer region, an upper side and a lower side; and at least one seal releasably mounted on the carrier ring, said seal being arranged for sealing engagement with a sealing part, wherein the seal comprises at least one flexible elongate body having first and second ends, wherein the flexible elongate body is bent to conform to the shape of a part of the carrier ring.

In some embodiments the flexible elongate body is bent into a substantially annular shape.

In some embodiments the elongate body is bent into a segment of an annulus. The seal can include a plurality of flexible elongate bodies. Preferably the plurality of flexible elongate bodies are arranged on the carrier ring in a substantially annular shape.

In preferred embodiments the sealing assembly includes a plurality of seals. Preferably each seal comprises at least one flexible elongate body having first and second ends. Brief description of drawings

A specific implementation of the present invention will now be described, by way of example only, and with reference to the accompanying drawings in which:

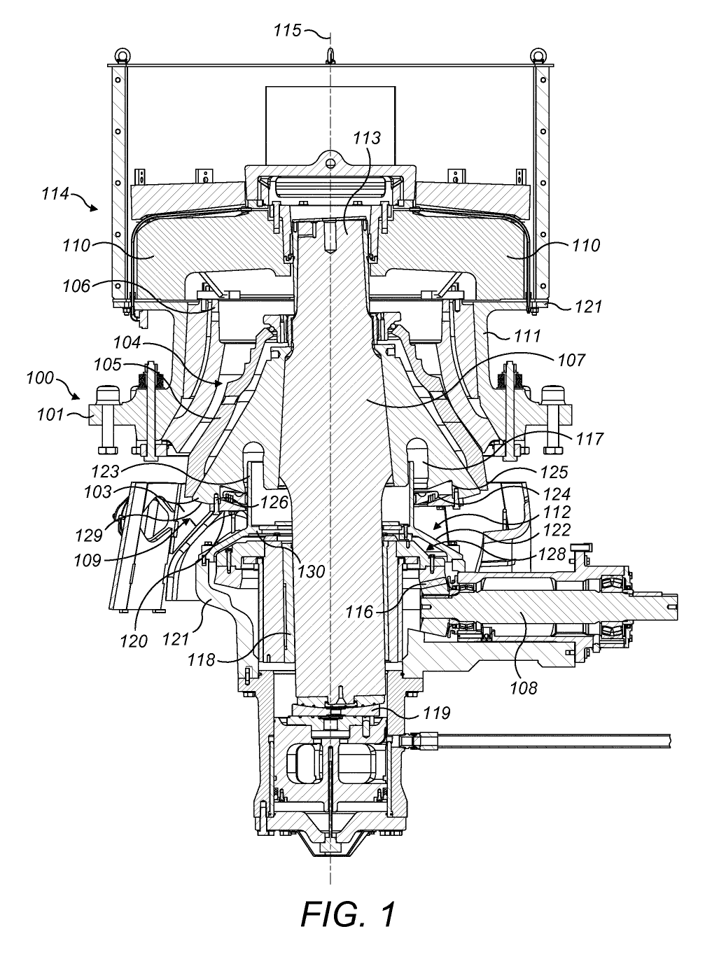

FIG. 1 is a partial cut-away isometric view of a gyratory crusher illustrating a crushing chamber, discharge zone and working part zone, the working part zone accommodating the drive components and bearings that provide and support gyroscopic precession of a head within the crushing chamber according to a specific implementation of the present invention;

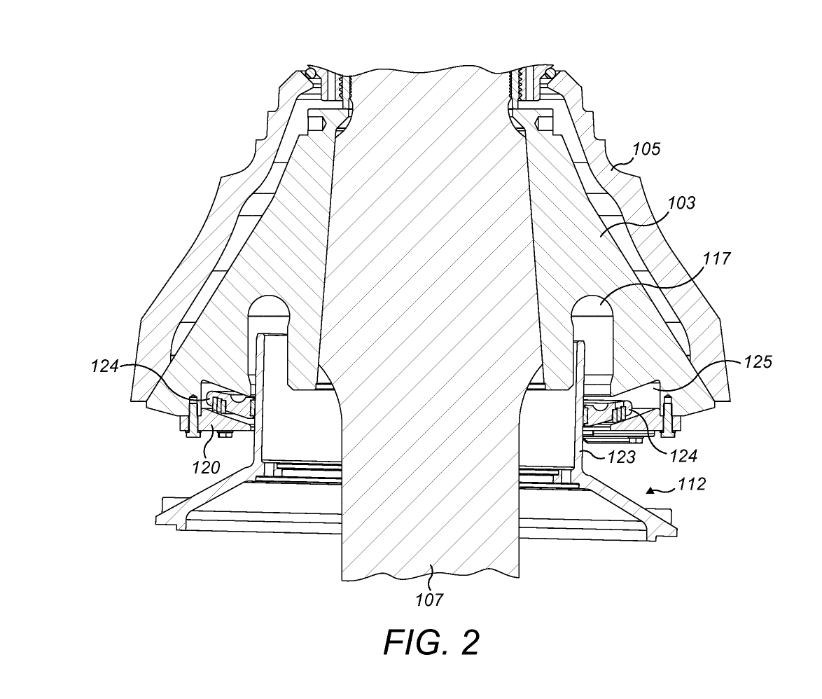

FIG. 2 is a cross-sectional view of part of the crusher of the FIG. 1, showing a sealing arrangement for separating the discharge zone from the working part zone, the sealing arrangement including a sealing assembly, a first sealing part in the form of a dust collar and a second sealing part in the form of a seat attached to a lower region of the head;

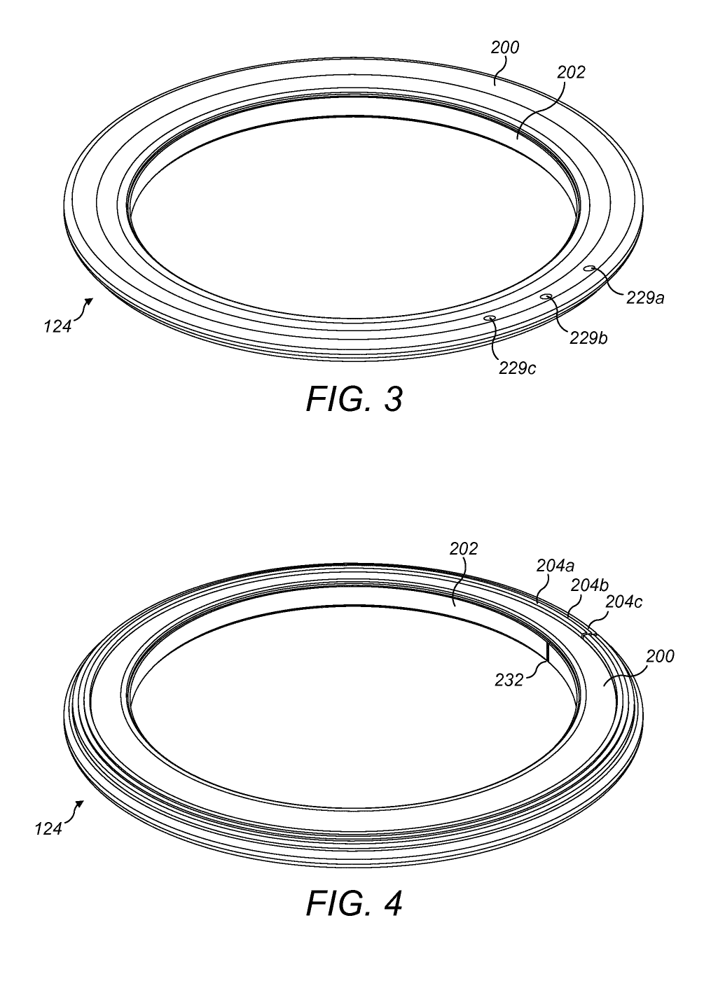

FIG. 3 is an isometric view from above of the sealing assembly of FIG. 2;

FIG. 4 is an isometric view from below of the sealing assembly of FIG. 2;

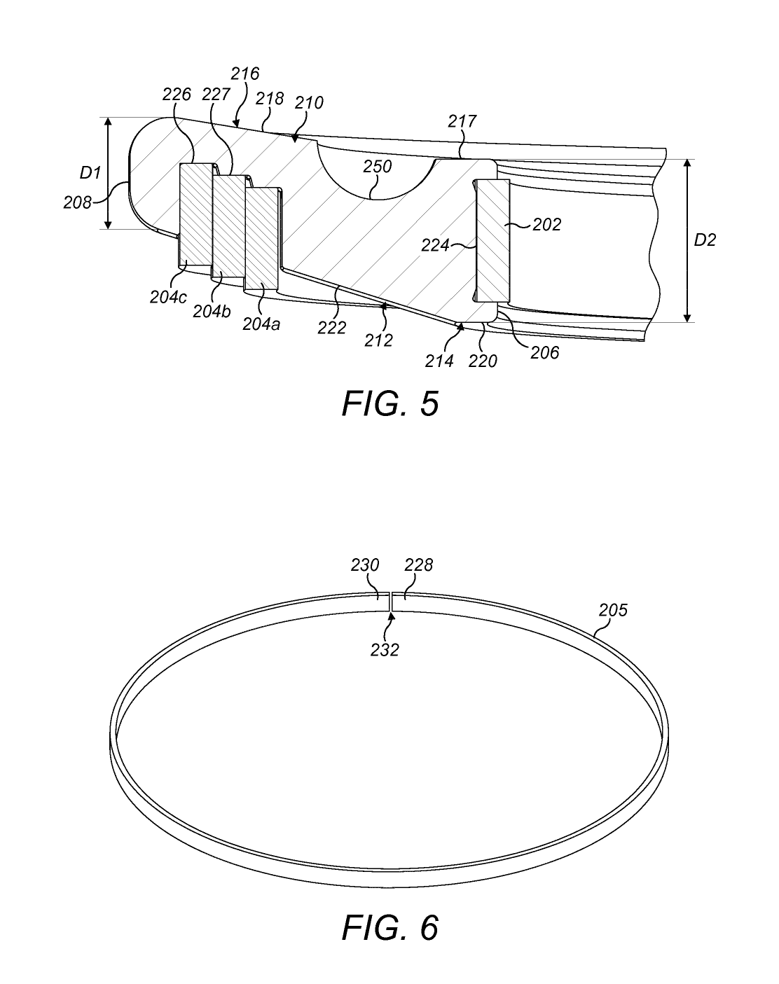

FIG. 5 is an enlarged transverse cross-sectional view of the sealing assembly of FIG. 2;

FIG. 6 is an isometric view from above of one of the seals from the sealing assembly of FIG. 2;

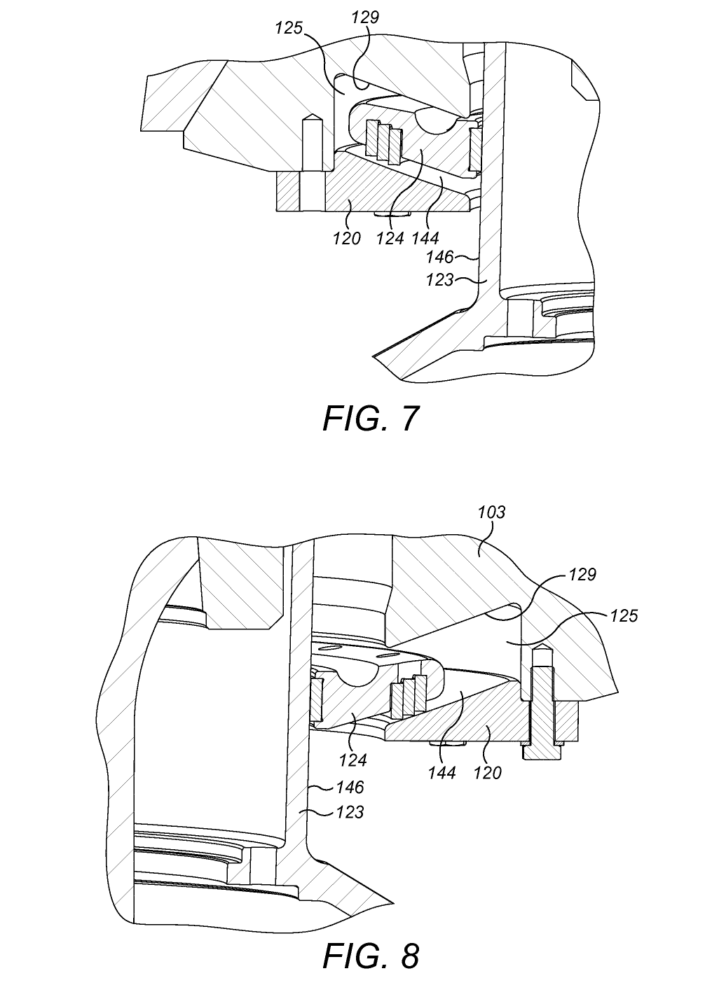

FIG. 7 is an enlargement of part of FIG. 2, showing the sealing assembly journalled against the dust collar and in sealing engagement with the seat, and illustrating a position of the head relative to a first part of the sealing assembly due to the gyroscopic precession of the head; and

FIG. 8 is an enlargement of part of FIG. 2, showing the sealing assembly journalled against the dust collar and in sealing engagement with the seat, and illustrating a position of the head relative to a second part of the sealing assembly due to the gyroscopic precession of the head.

### DETAILED DESCRIPTION OF PREFERRED EMBODIMENT OF THE INVENTION

Referring to FIG. 1, a crusher comprises a frame 100 having an upper frame 101 and a lower frame 102. A crushing head 103 is mounted upon an elongate shaft 107. A first (inner) crushing shell 105 is fixably mounted on crushing head 103 and a second (outer) crushing shell 106 is fixably mounted at upper frame 101. A crushing zone 104 is formed between the opposed crushing shells 105,106. A discharge zone 109 is positioned immediately below crushing zone 104 and is defined, in part, by lower frame 102.

Upper frame 101 is further divided into a topshell 111, mounted upon lower frame 102 (alternatively termed a bottom shell), and a support spider 114 that extends from topshell 111 and represents an upper portion of the crusher. The spider 114 comprises two diametrically opposed arms 110 that extend radially outward from a central boss (not shown) positioned on a longitudinal axis 115 extending through frame 100 and the gyratory crusher generally. Arms 110 are attached to an upper region of topshell 111 via an intermediate annular flange 121 that is centred around longitudinal axis 115. Typically, arms 110 and topshell 111 form a unitary structure and are formed integrally.

A drive (not shown) is coupled to main shaft 107 via a drive shaft 108 and suitable gearing 116 so as to rotate shaft 107 eccentrically about longitudinal axis 115 and to cause head 103 to perform a gyratory pendulum movement and crush material introduced into crushing chamber 104. An upper end region 113 of shaft 107 is maintained in an axially rotatable position by a top bushing (not shown) positioned intermediate between main shaft region 113 and the central boss (not shown). Similarly, a bottom end 118 of shaft 107 is supported by a bottom-end bearing assembly 119.

The crusher comprises a working part zone 128 that accommodates the bearing assemblies and drive components positioned immediately about the main shaft 107 below mantle 103 and towards the shaft bottom end 118. The working part zone 128 is partitioned from the discharge zone 109 by a sealing arrangement principally comprising a sealing part in the form of an annular dust collar 112 and a sealing assembly 124. Dust collar 112 comprises a first flange 122 having a radially outermost end releasably attached to an uppermost end of a mounting jacket 121 extending circumferentially about the bottom end 118 of shaft 107. A radially innermost end of flange 122 is divided into a short lateral flange 130 aligned transverse to flange 122 and orientated towards the outer surface of shaft 107. First flange 122 further divides into a third substantially vertical flange 123 that is aligned generally coaxially with shaft 107 and extends upwardly into head 103. In particular, flange 123 is accommodated within an annular cavity 117 that extends upwardly into head 103 from its bottom face 129. Cavity 117 flairs radially outward towards the underside 129 of the head.

A seat 120 is releasably attached to the underside 129 of the head. The seat is in the form of a retaining ring 120. The retaining ring 120 is releasably secured to the bottom face 129 of the head 103 via attachment threaded bolts 126 received within complementary threaded bore holes that extend upwardly into the head 103 from its lowermost face 129. The underside 129 of the head and the retaining ring 120 define an annular groove 125. The annular groove 125 faces inwardly towards the third flange 123. The annular groove 125 is inclined slightly with respect to the longitudinal axis 115 of the crusher, such that the radially inner most region of the groove is positioned lower than the radially outer most region of the groove.

The sealing assembly 124 is at least partially accommodated within the groove 125. The retaining ring 120 effectively sandwiches the sealing assembly 124 between flange 123 of collar 112 and the walls that define groove 125 in the underside region of head 103. The sealing assembly 124 is journalled against an outer surface of vertical flange 123 of dust collar 112. The assembly 124 extends circumferentially around the vertical flange 123. The circumferential sealing contact between sealing assembly 124 and dust collar 112, and the sealing assembly 124 and retaining ring 120, provides an effective seal to partition the working part zone 128 from the dust laden discharge zone 109.

Referring to FIGS. 3 to 4, the sealing assembly 124 includes a carrier ring 200. The sealing assembly 124 includes a seal 202 for sealing engagement the vertical flange 123 (hereinafter referred to as “flange seal”). The sealing assembly 124 includes at least one seal 204a-c for sealing engagement with the retaining ring 120 (hereinafter referred to as “retaining ring seal”).

The carrier ring 200 comprises an annular body. The carrier ring 200 has a radially innermost face 206 and a radially outermost face 208. The carrier ring 200 further comprises an upward facing face 210 and a corresponding downward facing face 212. The carrier ring 200 includes an annular inner portion 214, which extends in a substantially radial direction. The carrier ring 200 includes and an annular outer portion 216, which extends radially outwardly and upwardly from the inner portion 214. This is illustrated in cross-section in FIG. 5. The upward facing face 210 includes a substantially horizontal portion 217 and an upwardly inclined portion 218. The downward facing face 212 includes a substantially horizontal portion 220 and an upwardly inclined portion 222. Preferably the arrangement is such that the depth D₁ of the ring 200 at the inner face 206 is greater than the depth D₂ at the ring 200 towards the outer face 208.

A first groove 224 is formed in the radially inner most surface 206 of the carrier ring. The first groove 224 extends annularly around the carrier ring 200. The first groove 224 is arranged to receive the flange seal 202. The depth of the groove 224 is such that, when the flange seal 202 is seated in the first groove 224, the flange seal 202 protrudes beyond, in a radially inward direction, the innermost face 206 of the carrier ring (see FIG. 5). This enables the flange seal 202 to engage the vertical flange 123, without the carrier ring 200 engaging the vertical flange 123.

A second groove 226 is formed in the downward facing face 212 of the carrier ring. The second groove 226 is formed in the annular outer portion 216, in the upwardly inclined portion 222. The second groove 226 extends annularly around the carrier ring 200. The second groove 226 is arranged to receive three retaining ring seals 204a-c. Each retaining ring seal 204a-c has a different radial position, and hence a different circumferential size. The retaining ring seals 204a-c are seated in the second groove 226 such that the seals 204a-c protrude beyond the downward facing face 212 (see FIG. 5) in the region of the second groove 226. This enables the seals 204a-c to engage the an inclined upper surface 144 of the retaining ring 120 to provide a sealing affect while the crusher is operating, and a the same time preventing the carrier ring 200 engaging the retaining ring 120.

The retaining ring seals 204a-c protrude downwards in a substantially axial direction. The retaining ring seals 204a-c protrude downwards in a stepped fashion. The radially innermost retaining ring seal 240a, protrudes furthest in the downwards direction. The radially outermost retaining ring seal 204c, protrudes least in the downwards direction. The retaining ring seal 204b, which is located radially between the innermost and outermost retaining ring seals 204a,204c, protrudes in the downwards direction less than the innermost retaining ring seal 204a, but further than the outermost retaining ring seal 204c. This can be achieved, for example by providing the second groove 226 with a stepped seating 227.

A third annular groove 250 is formed in the carrier ring 200. The third annular groove 250 is mainly included to reduce the weight of the carrier ring 200. The third annular groove 250 is formed in the upward facing face 210 of the carrier ring, and preferably in the upwardly inclined portion 218. The third annular groove 250 can also assist with the manufacture of the carrier ring 200, for example to simplify machining the interface between the horizontal portion 216 and an upwardly inclined portion 218.

At least one hole 229a-c (three are shown in FIG. 3) is formed through the thickness of the carrier ring 200. The holes 229a-c are positioned and sized to enable a tool, such as a screwdriver, to be inserted into each hole 229a-c. The tool is used to push the retaining ring seals 204a-c out of the second groove 226, thereby enabling a user to manually remove the seals 204a-c.

The carrier ring 200 is typically made from metal, such as at least one of aluminium or steel. Aluminium is preferred because of its low density. Aluminium is also sufficiently resistant to dust particles, and can cope with the temperatures and wetting experienced during a crushing operation, without significant deformation occurring.

Each of the seals 202,204a-c comprises an elongate flexible strip 205 having first and second ends 228,230. The flexible strip 205 has a substantially rectilinear arrangement, prior to bending. The length of the flex strip 205 is cut to size to substantially match the circumference of the carrier ring 200 where the seal 202,204a-c is located. The flexible strip 205 is then bent into an annular shape (see FIG. 6) and fitted to the carrier ring 200 to function as a seal 202,204a-c.

For example, the flange seal 202 can be formed from a first flexible strip 205 having first and second ends 228,230. The length of the first flexible strip 205 is cut to match the circumference of the first annular groove 224. The first flexible strip 205 is fitted into the first annular groove 224 along substantially the full length of the groove 224. It can be seen from FIGS. 3 and 4 that the first strip 205 substantially fills the first groove 224, such that the first end 228 is located adjacent the second end 230, thereby forming a substantially annular seal 202. Preferably the first and second ends 228,230 are in abutting engagement when the strip has been fully fitted, however in practice sometimes there is a small gap 232 between the first and second ends 228,230. A gap size of 5mm or less is usually acceptable. The amount of dust passing through a gap of 5mm or less is minimal, and does not significantly affect operation of equipment in the working zone 128.

The first, second and third retaining ring seals 204a-c are each formed flexible strips 205 and mounted in the second groove 226, in a similar manner to the flange seal 202 in the first groove 224.

Typically each seal 202,204a-c is maintained in place by a tight fit with its respective groove 224, 226.

The flexible strips 205 can be made, for example by an extrusion process. It also enables the same flexible strips 205 to be used for all of the seals 202,204a-c, it just being necessary to cut the strips 205 to the appropriate length to match the circumference of the carrier ring 200 at the radial location of the seal 202,204a-c. Typically, each elongate strip 205 has a rectangular cross-section (see FIG. 5). Typical dimensions are: width in the range 5 to 12 mm; height in the range 15 to 40 mm; and length in the range 500 mm to 4000 mm.

Preferably the seals 202,204a-c are made from a plastics material such as a polyethylene based material and/or a composite material such as carbon fibre, or glass fibre.

The operation of the sealing assembly 124 will now be described with reference to FIGS. 1, 2, 7 and 8.

In use, the sealing assembly 124 is located in the annular groove 125. The sealing assembly 124 is configured and positioned circumferentially against an outer surface 146 of the dust collar 112, and in particular such that the flange seal 202 is positioned in sealing contact against the vertical flange 123. Accordingly, the seal 202 when mated against outer surface 146 provides a first primary seal to partition discharge zone 109 from working part zone 128. The configuration of the seal 202 and carrier ring 200 is such that the seal 202 protrudes beyond the radially inner most surface of the carrier ring, and therefore the carrier ring 200 does not contact the dust collar 112 in normal use.

The sealing assembly 124 is positioned and oriented in the groove 125 such that at least one of the retaining ring seals 204a-c has some sealing contact with the retaining ring 120, and in particular has some sealing contact with an upward facing inclined surface 144 of the retaining ring. The sealing contact between at least one of the retaining ring seals 204a-c and the sealing ring 120 provides a secondary seal for the separation of respective zones 109,128. Since the seals 204a-c protrude beyond the downward facing surface 112 of the carrier ring, at least in the position where the seals 240a-c are located, the carrier ring 200 does not contact the retaining ring 120 in normal use.

As head 103 is caused to rotate gyroscopically by drive shaft 108 and gears 116, sealing assembly 124 is displaced to move axially (vertically) relative to dust collar 112, by a limited amount. Accordingly, the radially innermost face of the flange seal 202 slides over surface 146, however it remains in tight mating contact with that surface to prevent any dust particles and the like from passing from the discharge zone 109 upwardly into mantle cavity 117 and subsequently contaminating working part zone 128. Thus the flange seal 202 also functions as a scraper to wipe contaminant particles from the collar outer surface 146.

The head 103 and retaining ring 120 rotate as a unit. The unit is caused to rotate gyroscopically by the drive shaft 108 and gears 116. The processional movement of the unit causes the retaining ring 120 to rotate with respect to the sealing assembly 124, and to adjust its radial position with respect to the sealing assembly 124. This is illustrated in FIGS. 2, 7 and 8, where it can be seen that the gap between the outer surface of the carrier ring 200 and the head 103 on the left hand side is significantly smaller than the gap between the outer surface of the carrier ring and the head 103 on the right hand side. Rotation of the unit causes the retaining ring seals 204a-c slide over the upper inclined surface 144 of the retaining ring 120, in a manner that maintains at least some sealing contact with the retaining ring 120. This prevents dust particles and the like from passing from the discharge zone 109 upwardly into mantle cavity 117 via groove 125, and subsequently contaminating working part zone 128, or at least significantly reduces the quantity of dust passing into the working zone. Thus the retaining ring seals 204a-c also function as scrapers to wipe contaminant particles from the retaining ring 120.

The present sealing assembly 124 is therefore effective to prevent particulates from passing upwardly beyond a lower region of collar surface 146 and into working part zone 128.

A significant advantage of the invention is that the carrier ring 200 is reusable. The carrier ring 202 does not wear away since it provides no sealing function itself and does not contact parts which move relative to it. Therefore it is only necessary to replace the seals 202,204a-c, as they wear. This reduces cost and waste. Since the carrier ring 202 does not itself provide a sealing function, the carrier ring 202 can be made from materials other than those which are suitable for sealing. For example, the material can be selected to better resist operating temperatures, the effects of water and dust, and therefore is more robust than prior art sealing rings. Another advantage is that, since the seals 202,204a-c are formed from elongate flexible strips, the seals can be fabricated easily. Also, the same stock material can be used for each seal 202,204a-c, it just being necessary to cut the stock material to the correct length. The flexible strips are easy to fit to the carrier ring 200, and are easy to remove therefrom.

According to further specific implementations, the sealing assembly 124 can include a different number of retaining ring seals 204. For example, the sealing assembly can include one, two, or four retaining ring seals 204. Any practicable number of retaining ring seals can be used. The second groove 226 is adapted accordingly to accommodate the selected number of seals.

Instead of providing a single stepped groove 226 to accommodate all of the retaining ring seals 204, a plurality of grooves 226 can be provided. For example, each seal 204 can be mounted in a separate groove 226.

The sealing assembly can include at least one seal that is arranged to protrude from the outermost edge 208 of the carrier ring to engage the underside 129 of the head 103.

The sealing assembly can include at least one seal that is arranged to protrude from the upward facing face 210 of the carrier ring to engage the underside 129 of the head 103.

The carrier ring can be made from a different material. For example, the carrier ring can be made from different metals. The carrier ring can include a composite material, for example may include carbon fibre and/or glass fibre.

The carrier ring may have a composite structure, which includes a plurality of materials.

At least one of the seals 202,204a-c can comprise a plurality of flexible strips 205. Each flexible strip forms a segment of the annular seal 202,204a-c. Each flexible strip is mounted on to the carrier ring. Adjacent strips are mounted end to end, such that the overall shape is substantially annular. It will be appreciated that there may be small gaps between the ends of adjacent annular segments. A seal formed in this manner typically includes between 2 and 10 annular segments, however any practicable number of segments can be used.

1. A sealing assembly for a gyratory crusher, the gyratory crusher having a crushing chamber defined between an outer and an inner crushing shell with a discharge zone to allow crushed material out of the crushing chamber, the inner crushing shell being supported on a head mounted at a main shaft, wherein a working part zone is positioned below the head and about the shaft and includes working parts to enable the head to move gyroscopically within the crusher, the sealing assembly is being configured for positioning between the discharge zone and the working part zone, the sealing assembly comprising:
a reusable carrier ring having a radially inner region, a radially outer region, an upper side and a lower side; and
at least one seal releasably mounted on the carrier ring that is arranged for sealing engagement with a sealing part, wherein the at least one seal protrudes beyond a mounting region of the carrier ring such that, in use, the at least one seal maintains the carrier ring out of engagement with the sealing part.

2. The sealing assembly according to claim 1, wherein the at least one seal is mounted to the carrier ring in the radially inner region, and the at least one seal protrudes beyond the carrier ring in a radially inwards direction.

3. The sealing assembly according to claim 1, wherein the at least one seal protrudes outwardly from at least one of the upper and lower sides of the carrier ring.

4. The sealing assembly according to claim 1, wherein the at least one seal protrudes outwardly from the radially outer region of the carrier ring.

5. The sealing assembly according to claim 1, wherein the at least one seal includes a first seal releasably mounted on the carrier ring in the radially inner region, the first seal being mounted to the carrier ring at a first radial distance and protrudes beyond the carrier ring in a radially inwards direction to sealingly engage a first sealing part; and a second seal releasably mounted on the carrier ring, said second seal is being positioned on the carrier ring at a second radial distance, said second radial distance being larger than the first radial distance, wherein the second seal protrudes outwardly from the lower side of the carrier ring to sealingly engage with a second sealing part.

6. The sealing assembly according to claim 5, wherein the at least one seal includes at least one additional seal releasably mounted on the carrier ring, the at least one additional seal is being positioned on the carrier ring at a radial distance that is larger than the first radial distance, and different from the second radial distance, wherein the at least one additional seal protrudes outwardly from the lower side of the carrier ring to sealingly engage the second sealing part.

7. The sealing assembly according to claim 6, wherein the second seal and the at least one additional seal is arranged such that the parts of the seals that engage the second sealing part have a stepped arrangement.

8. The sealing assembly according to claim 5, wherein the first seal is seated in a first annular groove formed in the carrier ring, and the first annular groove faces radially inwards.

9. The sealing assembly according to claim 5, wherein the second seal is seated in a second annular groove formed in the lower side of the carrier ring, and the second annular groove faces downwards.

10. The sealing assembly according to claim 1, wherein at least one of the seals includes at least one flexible elongate body having first and second ends, wherein the flexible elongate body is bendable to conform to the shape of part of the carrier ring.

11. The sealing assembly according to claim 10, wherein, in use, the first end of the flexible body is located adjacent to the second end of the flexible body, or is located adjacent to an end of an adjacent flexible body.

12. The sealing assembly according to claim 1, wherein in the carrier ring includes a body, which includes at least one of: a metal, such as aluminium and/or steel; and a composite material, including carbon fibre and/or glass fibre.

13. A gyratory crusher comprising:
an outer and an inner crushing shell with a crushing chamber defined therebetween;
a discharge zone arranged to allow crushed material out of the crushing chamber;
a head mounted upon a main shaft and configured to support the inner crushing shell;
a plurality of working parts positioned below the head about the main shaft within a working part zone to enable the head to move gyroscopically within the crusher; a sealing assembly positioned at an interface between the discharge zone and the working part zone, the sealing assembly comprising:
a reusable carrier ring having a radially inner region, a radially outer region, an upper side and a lower side; and
at least one seal releasably mounted on the carrier ring that is arranged for sealing engagement with a sealing part, wherein the at least one seal protrudes beyond a mounting region of the carrier ring such that, in normal use, the seal maintains the carrier ring out of sealing engagement with the sealing part.

14. The crusher according to claim 13, including an annular dust collar positioned about the main shaft at the interface between the discharge zone and the working part zone, wherein the sealing assembly is positioned in sealing contact with a radially outward facing surface of the dust collar.

15. The crusher according to claim 13, including a seat provided at a lower region of the head, the seat being configured to positionally support the sealing assembly in position between the head and the dust collar, wherein the sealing assembly is positioned in sealing contact with an upper surface of the seat.

16. The sealing assembly according to claim 10, wherein the flexible elongate body is bent into a substantially annular shape.
